(19) United States
(12) Patent Application Publication
(10) Pub. No.: US 2012/0150680 A1
(43) Pub. Date: Jun. 14, 2012

(54) Automated Publishing Systems and Methods

(75) Inventors: Maribeth Carlisle Golus, Dubuque, IA (US); Kaushik Sampath, Dubuque, IA (US)

(73) Assignee: QBEND LLC, Dubuque, IA (US)

(21) Appl. No.: 13/321,941

(22) PCT Filed: May 25, 2010
(86) PCT No.: PCT/US2010/036071

§ 371 Date: Jan. 30, 2012

Related U.S. Application Data
(60) Provisional application No. 61/181,150, filed on May 26, 2009.

(51) Int. Cl. G06Q 30/00; G06F 17/30

(52) U.S. Cl. 705/26.5; 707/756; 707/E17.044

(57) ABSTRACT

Provided is an automated publishing system that can include a database indexed to store contribution data that includes portions of works of authorship, a user authentication system configured to authenticate a member to the system, and a virtual work area having a graphic user interface accessible by the member. The interface can include content searching and content collating features such that a member can generate a custom work by selecting a plurality of different portions of works of authorship which are combined to generate the custom publication. The interface in addition contains an option for a member to add content at the end of each chapter, when such member is authorized by the publisher. The custom publication can be sent to the publisher for approval and is made available only after the publisher grants approval.

### CROSS REFERENCE TO RELATED APPLICATION(S)

This application claims priority to U.S. Provisional Patent Application No. 61/181,150, filed May 26, 2009, the entire disclosure of which is incorporated herein by reference.

### FIELD OF THE INVENTION

The invention relates generally to the field of computer-based publishing and information management. Specifically, the invention relates to customizing content from various sources into one single publication.

### BACKGROUND

In general, if a person wishes to read a printed publication, he will have to either purchase the hard copy or pay for the copy and download the soft copy with an option to print the soft copy as and when needed. Further, publication availability is controlled by (1) the publisher, (2) the author, and (3) the form of the publication (physical form or in a downloadable form).

When a person needs more information regarding a publication, such as a book or magazine, then the normal course of action may be to check out other publications in that related field. Typically, most people today who want to find such information log onto the Internet and use a search engine. The search result that is generated can be quite time consuming to wade through as it is most probably a key word search and most of these traditional web searches do not include a search of printed publications.

For example, when such a search is typed in, the user is directed to a particular web page and not to the content in which the words occur and in such cases more information specifically selected by the author or the publisher can be found. Locating the exact document in which these words occur is still a step or two away as the user doing the search now has to go through the chapterwise content and then locate the necessary text he or she is looking for. One way to accomplish this is to print a Uniform Resource Locator (URL) in the printed publication (e.g., www.publisher.com/booktitle/moreinfo). Another mechanism for directing a reader to a web page is to print a barcode in the printed publication. The reader then scans the barcode, and associated software directs a connected computer to the appropriate web page. However, placing a large number of URLs and/or barcodes in a printed publication is distracting to the reader and consumes space in the printed publication otherwise reserved for content. In addition, typing long URLs is cumbersome, and many people do not have a barcode reader connected to their computer. Accordingly, new approaches to addresses these deficiencies are required.

Moreover, if the user wants to evaluate the information, the user must search through publisher after publisher and that by itself is not a solution, given the time consumed. Even after going through several of the publishers, the user might not end up with the right information that he seeks, as there is the next step of searching for the information in each of these publications/websites belonging to each publisher. The cost of downloading each of these soft copies or printed publications is also enormous, which has to be factored in the overall value proposition.

In addition to these issues, the user might be interested in only certain portions of the publication, which is not available under current offerings. As an example, if the user is interested in only a few chapters in the book, for which he has to pay for the entire book, and the option of purchasing a few chapters is not available, there is no easy solution to this problem.

Another drawback is that if a professor, an author or a publisher is interested in content modification, namely, the editing or revising the content on a particular topic across various publications, this is not easy to accomplish. Currently, no such action is possible, like collation of data on a particular topic, creating a new title for the work, providing it with a new International Standard Book Number (ISBN) number, etc and making it available for general public consumption.

Thus, for the reasons discussed above, document production and storage techniques are inadequate to generate, structure, and store multiple altered versions of a document. Furthermore, the ability to check and track changes made is slow and cumbersome due to the number of document comparisons that must be made. Therefore, there is a need for a system and method that assists and guides authors in creating structured documents that are automatically assembled, formatted, and reproduced to accurately reflect all of the elements of the system with minimal knowledge required of the author. A further need exists for a system and method for updating and maintaining such documents to reflect the specific elements actually used in the project.

### SUMMARY OF INVENTION

This invention aims to eliminate the drawbacks and deficiencies discussed above. Specifically, this is accomplished by first granting access to customized publications, which are stored electronically in either un-edited or edited formats, thereby reducing the time taken to identify the items for custom publishing. Second, a digital database software is used with a computer or processor to make available such custom publications to the end user or to the author to facilitate the creation of revised or custom published versions of written materials previously created by them.

In part, one embodiment of the invention relates to organizing a group of publishers using a remotely accessible processor based system who will, for a fee, give their content to a service provider to be housed on a server. The server includes indexed and searchable written materials. When a user enters the search term in using the service provider's website, the user is presented with the option of selecting various publications found pursuant to the search, from all the publications that are stored on the server. Thus, the need to go to different websites to gather information about different publishers is resolved.

Embodiments of this invention allow the user to download the content on a per chapter or per article basis from each publication, instead of having to purchase the entire publication. As a result, un-edited custom publications can be created. For the same or lower costs, the user can access, review, combine, and download different versions of the same content either from the same publisher or from different publishers.

Furthermore, a user can perform all of these functions at one location using a network such as the Internet. Thus, a user can log onto the relevant website, which hosts a group of publishers who have uploaded a variety of publications to enter in the search term(s), browse the collection of different publishers resulting from the query, choose to either download the entire publication or the relevant portion, and pay for the same. The website is navigated for the search terms, and the search result is analyzed, assembled, and published to be downloaded at a fraction of the cost and time of traditional approaches.

Editing the content as per customized author/publisher requirements is another feature of the invention. For example, a professor that teaches at a university would have a recommended reading list for his students. A website design based on the embodiments disclosed herein allow the professor to access content, collate chapters chosen for recommended reading, and custom publish the same with a new title, ISBN, etc. This simplifies the process of searching for publications and assembling customized specialty document collections.

Each publisher can authorize a person, for example, an author or professor, to access the contents belonging to the publisher. The publisher is engaged with the service provider to either add further content to already existing work such as answers to the questions at the end of each chapter, or adding a test at the end of each chapter etc., or to bring out a new work by going through relevant publications, collating the chapters/articles in each of these publications into a new book format, allocating it a new title, an ISBN, choosing a new layout, designing the cover etc. In all these endeavors, the insertions, if any, can occur at the end of each chapter as an add-on feature in the new publication. The published content provided to the service provider however, remains untampered. This is useful as the new work of authorship reduces the costs from purchase of many books to purchase of a single book, which covers the same issue discussed by various authors. This is particularly useful to impart a broader vision as to how the topic has been handled, at a fraction of the original costs. Moreover, such content can be accessed at any time, on any device on which the book has been downloaded. Such downloads are retained on the devices in electronic storage. A back up copy is permitted in such cases on another device which ensures that the user has access to the publication.

Embodiments of this invention are eco-friendly. Downloads of electronic documents do away with lugging around books, cut down the use of printed matter (paper), printing materials, labor, reduces environmental pollution and also the physical space that is required for such storage of such printed matter. The user of such a facility is also not bound by the requirement of internet access, once the publication is downloaded for use and future use.

In one embodiment the present invention relates to a user electronically selecting custom published works either customized by the user themselves or the author or the publisher by means of authoring and/or publishing software tools. More particularly, at least one embodiment provides for purchase or rental of parts of a publication. Yet another embodiment provides for authoring and publishing a work using a software tool. The software tool guides authorized personnel with authoring and publishing, using structured templates. The templates have defined content areas, electronic library (data pools) of permissible content, structured data storage, and synthetic text generation, which results in customized publications.

Digital data can be used in each publication in different fields across multiple industries. Benefits of using digital publications are expected for all users of the publications, from the producer to the end user.

One embodiment of the present invention assists users in automatically downloading customized content in relation to published works.

One feature provides a guided or structured software environment that assists users in creating customized content, namely, selection of a portion of publications, to be bought on a chapter-by-chapter basis. However, any logical part of a book or document can be used. For instance, in a cookbook, people can assemble specific recipes.

Another feature of the invention provides a guided or structured software environment that assists the persons authorized by the publisher to customize certain topics across their various publications, to revise the content that is already published or to upgrade their publications by adding or deleting certain content. Such custom publications are created by document definitions having data structures and defined content for each section, content rules and relationships, and tasks to be performed for each type of document entry. Predefined document definitions and data structures are used to facilitate the creation of data elements and compile a final book, manual, or document.

In one embodiment, a publisher's content is stored as structured data elements, rather than as sentences or paragraphs. By storing such content in this manner, it is more efficient to generate, revise, and store the content that needs to be published relative to sentence or paragraph storage. That is, rather than storing content as complete pages of text (e.g., sentences, paragraphs, tables, and/or graphics), the present invention stores the content as distinct data elements in a database. Typically, the chapters when given by the publisher are in PDF format and are converted into XML format. This conversion can be automatic during the custom publishing phase or can be provided on-demand at the publisher's request. The XML file itself is a structured document storing all the information within the chapter and thereby enabling the custom publishing engine to identify elements such as images, headings, paragraphs, tables that exist within each chapter, etc. This structure helps to provide the highest level of customization that is required prior to making available the customized copy for public use, for example, removal of images if the same do not have copyright clearances; addition of extra text at the end of a chapter, etc. The content is stored in the database by chapter and can comprise one single XML file containing all the details of that particular chapter. This XML file once created is available on server and can be made available to the publisher on-demand. Furthermore, different content from various publishers can be compiled using some of the same data elements, thereby saving storage space. Moreover, this approach of storing content permits a single data element to be modified to propagate that modification to all other publications referencing that data element.

Yet another novel feature of the invention provides the publisher with a watermarked copy of the final published content, which is available for commercial exploitation only when the publisher gives the approval. If the approval from the publisher is not provided, then the final content cannot be used. In one embodiment, a publishing engine publishes a user designated document by assembling the stored data elements and compiling them into a single document. Translated versions can also be generated using this invention with a software appropriate tool.

One implementation provides a method for authoring and publishing a document using one or more document definitions. A document definition includes a plurality of predefined data elements. Such a document definition defines the data type for content, rules governing such content, a structure for such content, and relationships with other data types.

In one embodiment, one or more of the predefined data elements are searched using content-specific selection menus and stored as selected data elements in a relational database to store a customized document. Text is automatically synthesized from the selected data elements by compiling the selected data elements according to the structure defined by the document definition to generate the customized document.

In some embodiments, an automated publishing system is provided. The automated publishing system can include a server comprising a processor, a storage device, and a database indexed to store contribution data, wherein the contribution data comprises portions of a plurality of works of authorship provided by a publisher. The system also can include a user authentication system configured to authenticate a contribution user and grant permissions to at least one member, wherein the contribution user can collate content from the database or populate the database with contribution data and request the service provider to customize such content into custom publications. The system can further include a virtual work area having a graphic user interface accessible by the at least one member using a browser, wherein the interface comprises content searching and content collating features such that the at least one member can generate a custom work by selecting a plurality of different portions of works of authorship, wherein the selected plurality of different portions are combined using the processor in response to a member action using the interface, to generate the custom publication. The custom publication is made available after the publisher approves the custom publication.

Various embodiments of the automated publishing system can include one or more of the following features. In some embodiments, the system can include an image permission subsystem that evaluates images selected for inclusion in the custom work, and which authorizes the inclusion of the image if certain permission values are detected. In some embodiments, the portions of a plurality of works of authorship can be structured data elements, and/or the portions can be selected books which can be classified chapterwise. In various embodiments, the contribution user or the at least one member can be selected from the group consisting of publisher, content aggregator, university, online merchant, student, researcher, renter, and combinations thereof. In some embodiments, the database can include a plurality of contribution fields to store contribution data, and the contribution data can be stored as individual units or as an aggregation of such individual units. In some embodiments, the software executing on the processor can receive information collated by the contribution user and can generate an XML based configuration file in response thereto. In various embodiments, each portion can be stored as a logical content unit. In some embodiments, the use permission information for each logical content unit can be stored as a separate XML file in an associated permission entry in the database. In some embodiments, the virtual work area can provide conversion options to other formats through a unified interface.

In some embodiments, a computer system for publishing a custom digital work is provided. The computer system can include an electronic memory device and an electronic processor in communication with the memory device. The memory device can include instructions that when executed by the processor cause the processor to: process a plurality of selected sections from different works; store the sections input through the interface in an order file determine availability of a common file format for the plurality of sections stored in a database by reading contents of the order file; if common file format does not exist, convert files associated with the plurality of sections to the common file format; and combine the plurality of selected sections using the common file format to generate the custom digital work.

Various embodiments of the computer system can include one or more of the following features. In some embodiments, the instructions on the memory device can further cause the processor to: add metadata to the custom digital work; obtain permission information to add or remove images to the digital work; and add digital work publication information to the digital work. In some embodiments, the common file format can be XML. In some embodiments, the digital work publication information can be selected from the group consisting of template, ISBN, title name, author name, copyright information, and format. In some embodiments, the permission information can be retrieved from a database and stored in a permission file. In some embodiments, the instructions can further cause the processor to: read the permission file and check for a print/web permission value. In some embodiments, the instructions can further cause the processor to: delete an image if the print/web permission value is a first value and retain the image if the print/web permission value is a second value.

### BRIEF DESCRIPTION OF THE DRAWINGS

The objects and features of the invention can be better understood with reference to the drawings described below. The drawings are not necessarily to scale, emphasis instead generally being placed upon illustrating the principles of the invention. In the drawings, like numerals are typically used to indicate like parts throughout the various views.

FIG. 1 is a block diagram illustrating a web page of a system, apparatus or method user, with its various options (e.g., the categories associated with various topics for which search terms are keyed, the purchase module, the authorized personnel avenue to enter the database, etc.), in accordance with an embodiment of the invention.

FIG. 2 is a flow chart depicting the working of an exemplary custom publishing engine, in accordance with an embodiment of the invention.

FIG. 3 is a series of screen shots for an exemplary publishing engine, according to an embodiment of the invention.

FIG. 4 is a block diagram illustrating an automatic authoring and publishing editor interface, according to an embodiment of the invention.

FIG. 5 is a block diagram illustrating the data structure of a relational storage database, according to an embodiment of the invention.

FIG. 6 illustrates a method for authoring a publication using a guided and structured document generation system, according to an embodiment of the invention.

FIGS. 7A and B illustrate a method for operating a publishing engine, according to an embodiment of the invention.

FIG. 8 illustrates a processor-based system by which a user can search for content, assemble, preview and receive the final publication, according to an embodiment of the invention.

FIG. 8A illustrates a network cloud diagram, in accordance with an illustrative embodiment of the invention

FIG. 9 illustrates the concept of conversion of format from one format to another by the click of the mouse, according to an embodiment of the invention.

### DETAILED DESCRIPTION

Methods and devices that implement various features of the invention will now be explained with reference to the drawings. These drawings and the associated descriptions are provided only to illustrate embodiments of the invention and not to limit the scope of the invention.

Other embodiments are possible and modifications may be made to the embodiments without departing from the spirit and scope of the invention. Therefore, the following detailed description is not meant to limit the present invention.

It should be understood that the order of the steps of the methods of the invention is immaterial so long as the invention remains operable. Moreover, two or more steps may be conducted simultaneously or in a different order than those recited herein unless otherwise specified.

It should be understood that the terms “a,” “an,” and “the” mean “one or more,” unless expressly specified otherwise. The foregoing, and other features and advantages of the invention, as well as the invention itself, will be more fully understood from the description and drawings.

In general, embodiments of the invention relate to various systems, methods, and devices suitable for allowing a user to Search, Navigate, Arrange, and Publish (SNAP) content elements, such as book chapters as outlined herein. These systems and methods can be implemented using a processor that executes instructions to carry out these steps in response to a user action. Typically, the processor is part of a server that is accessed via a network such as the Internet.

Prior to discussing the aspects of the publishing related embodiments in detail, an introduction to some of the characteristic terminology used herein may prove informative. However, the scope of the terms discussed herein is not intended to be limiting, but rather to clarify their usage and incorporate the broadest meaning of the terms as known to those of ordinary skill in the art.

The term “author” means a person who has created a work which is stored in the database by the publisher. The term “authorized personnel” means a person authorized by the publisher to create and publish a new “work”. The term “user” means a person who is using a method or system described herein such as has logged onto the database and is desirous of either renting or purchasing content from the database. In one embodiment, “database” refers to a database created using some of the approaches outlined herein. In one embodiment, a database is populated by collating the published works of different publishers and uploading the content onto a server, which is made available to the public in a machine readable form, for searching and downloading of the certain contents for the payment of a fee. The database typically stores and indexes various entries. Entries can include, but are not limited to individual sections, chapters, sentences, paragraphs or other portions of larger works of authorship.

The term “document” refers to any human or computer readable media. For example, document can refer to publications that are in the database that are readable including manuals, manuscripts, web pages, printable documents or other form capable of being read. The term “storage device” may refer to any device capable of storing information, including hard drives, dynamic random access memory (DRAM). The term “data element” refers to any quantum of data packaged as a single item. The term “data unit” refers to a collection of data elements and/or data units that comprise a logical section. The term “publications” refers to any books, manuals, journals etc that has been published by a publisher and which is stored in the database.

The term “storage medium” may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to, portable or fixed storage devices, optical storage devices, and various other mediums capable of storing, containing or carrying instruction(s) and/or data. The term “work” refers to any matter created by the authorized personnel such editing, amending, etc. of one or more existing publications to result in a new work.

One feature of the invention provides a guided or structured software environment that assists the author in creating documents by defining the appropriate data structures and content for each publication, content rules and relationships, and tasks to be performed for each type of manual entry. Predefined document definitions and data structures are used to facilitate the creation of data elements and compile a final book, manual, and/or document.

One feature of the invention provides for storing manual content as structured data elements, rather than as sentences or paragraphs, to more efficiently generate, revise, and store the content of a manual. That is, rather than storing content as complete pages of text (e.g., sentences, paragraphs, tables, and/or graphics), the present invention stores the content as distinct data elements in a database. This also allows different books, manuals, and/or documents to be compiled using the same data elements, thereby saving storage space. Moreover, this approach to storage of content permits a single data element to be modified to propagate that modification to all other books, manuals, and/or documents referencing that data element.

Yet another novel feature of the invention provides a preview that permits the publisher to quickly view what revisions will look like in a final document prior to actually publishing a work. A publishing engine publishes the work by assembling the stored data elements and compiling them into a single document, after clearing all the formalities checks.

A compiled document can be converted into a structured XML document (e.g., Docbook) and forwarded to a publishing engine where it is output in a user selected format. While this invention relates to several of the examples described herein which relate to electronic publishing services, this invention is applicable to all industries that use written materials and is not limited to one file format.

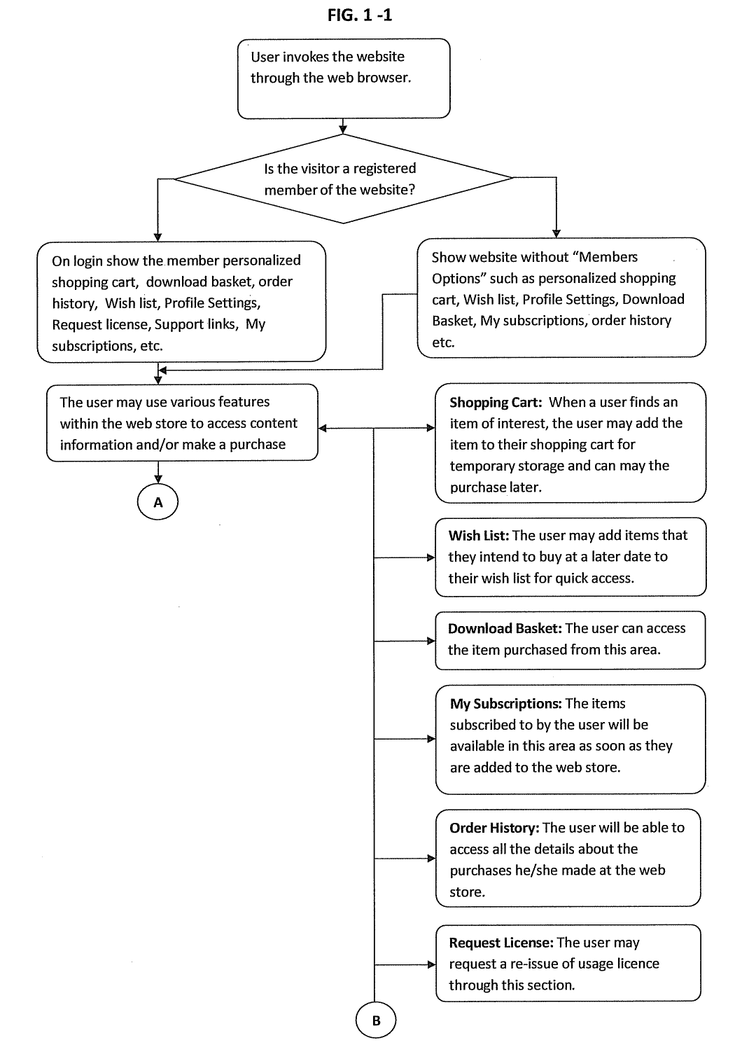

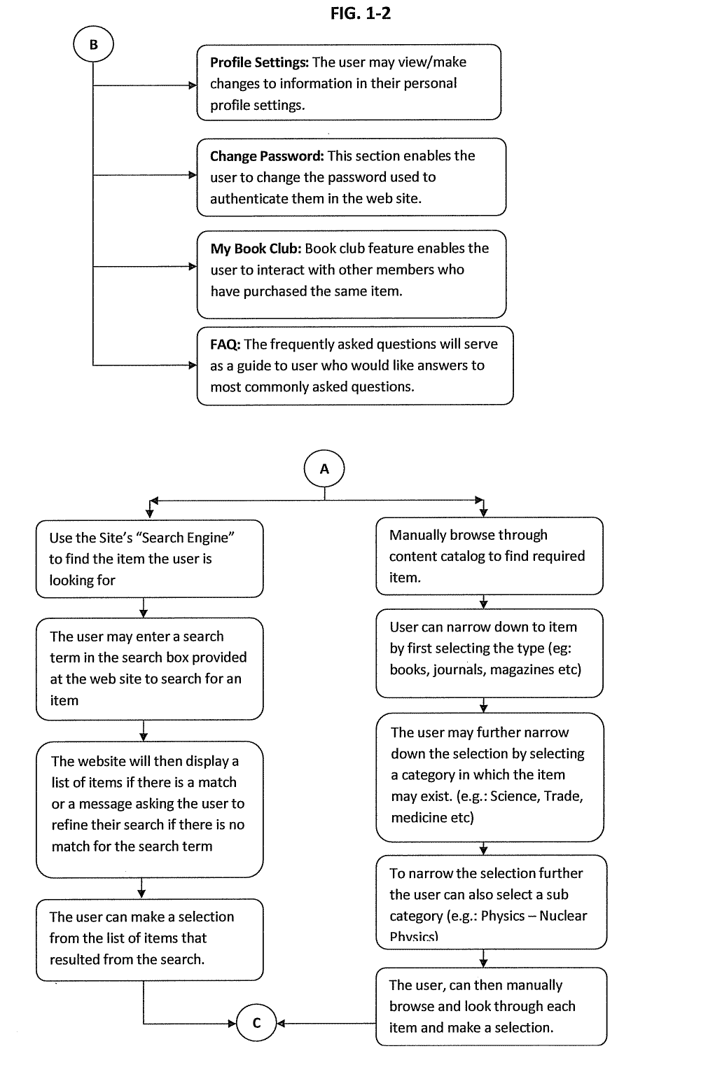

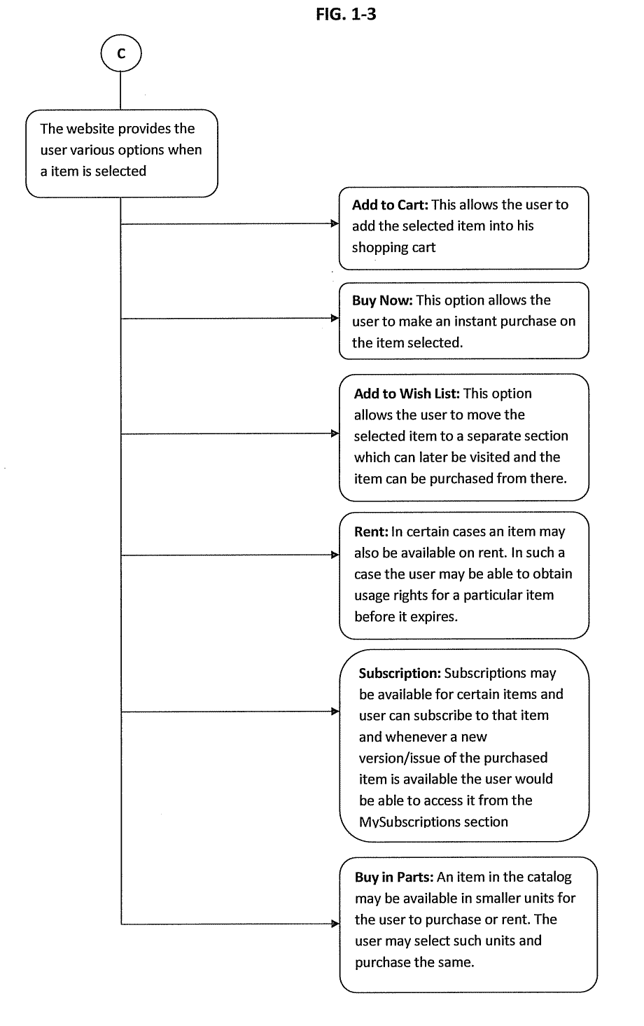

FIG. 1 is a flow chart illustrating a webstore, to illustrate the non-edited custom publishing embodiment. This is the webstore, wherein the user enters the website, browses through the website either manually or through the search engine which is an advanced search engine, finalizes his requirements and downloads the same. Some or all of the steps shown in FIG. 1 (and the other flow charts) have associated computer program logic or instructions that execute on a processor. The user has options of choosing published content chapterwise across various publishers and publications based on his search query. The user can drag and drop his selections in the shopping cart, either pay for them immediately or defer the payment, pay for the downloads completely or pay for a fixed time, rent the same for a fixed period, etc.

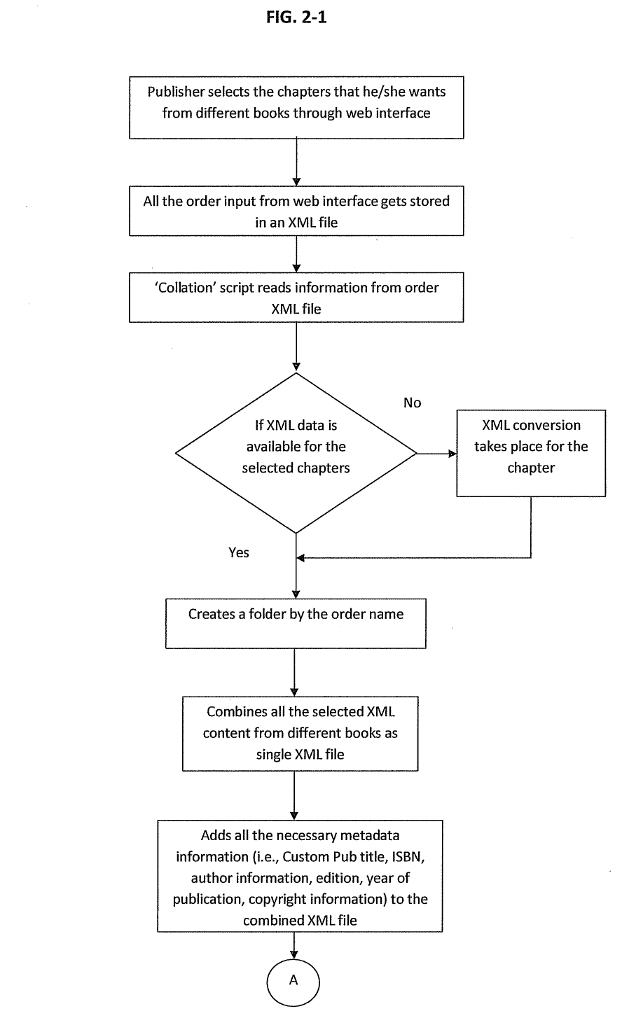

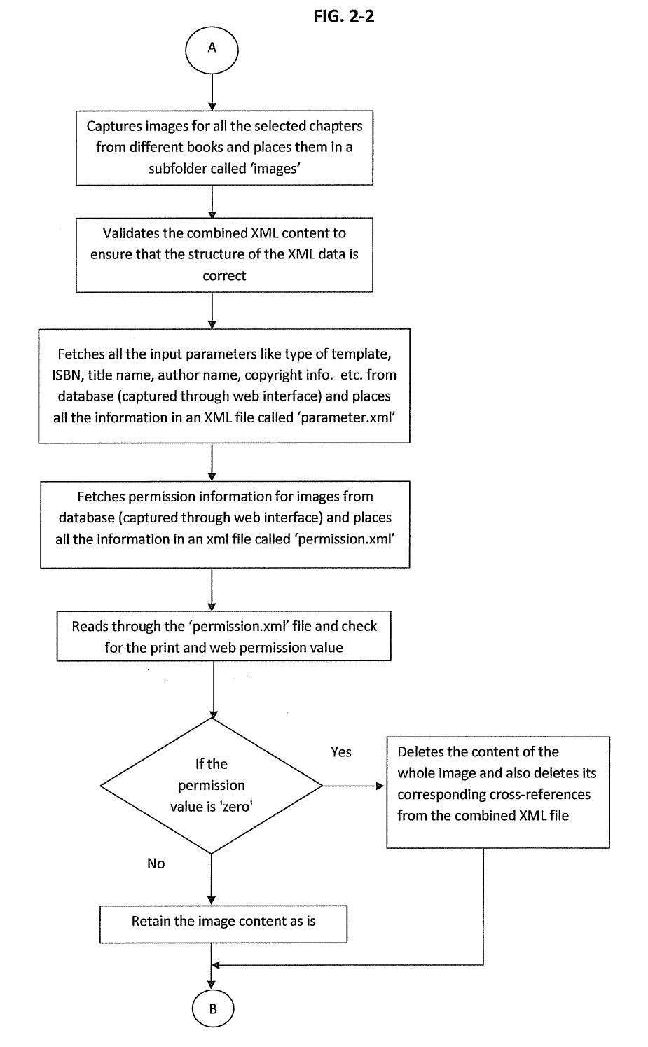

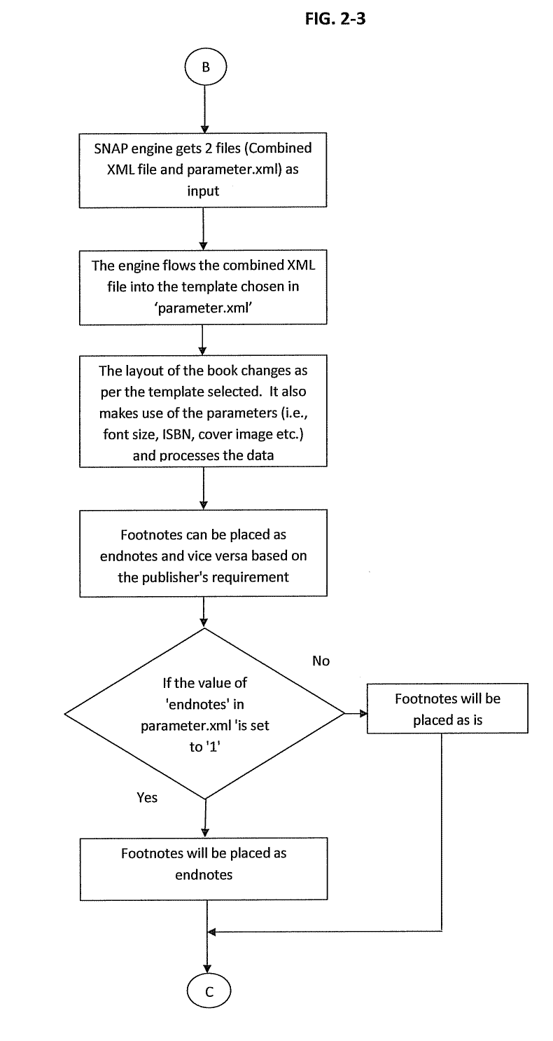

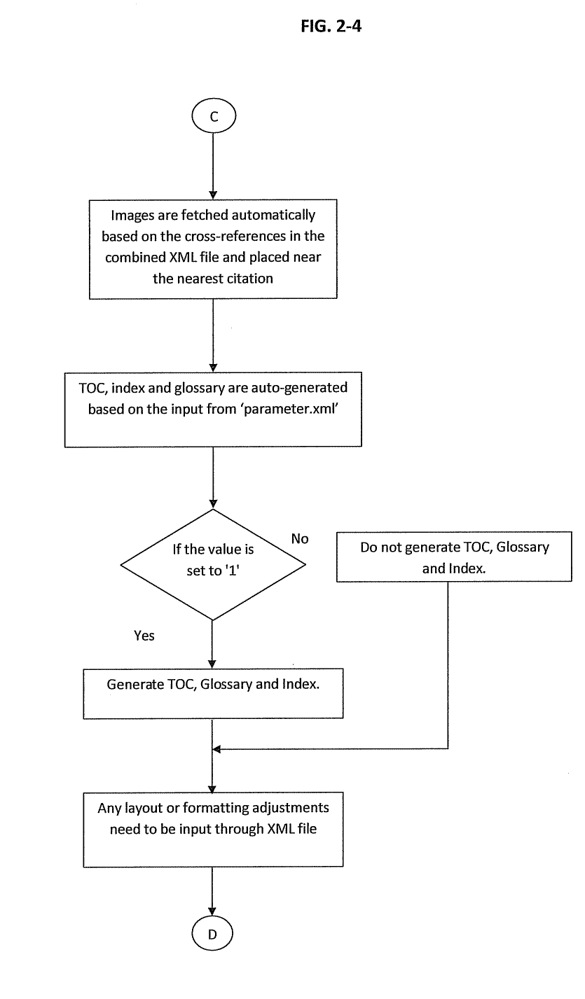

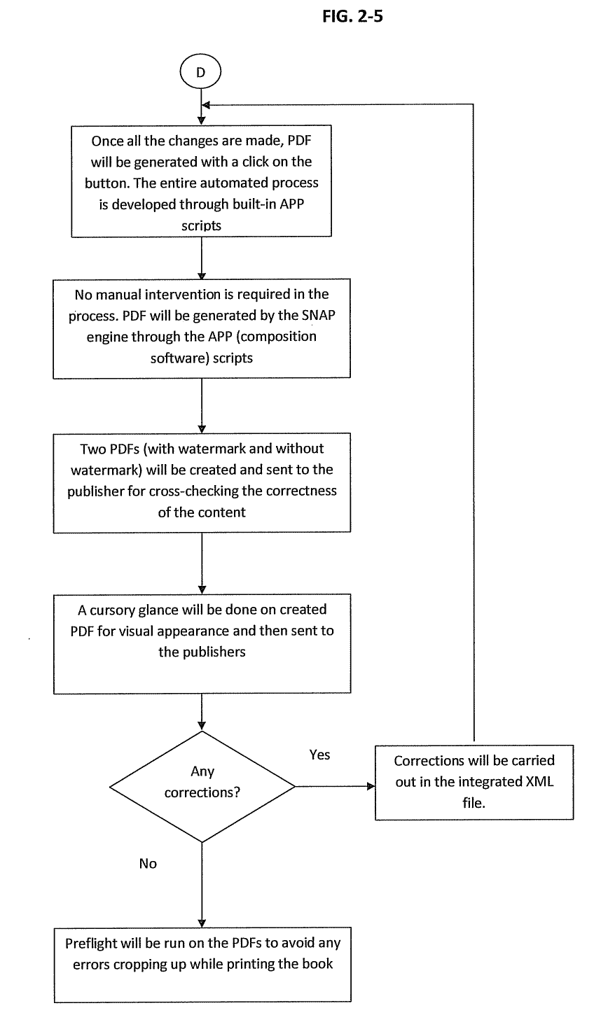

FIG. 2 is a flow chart depicting the operation of an exemplary custom publishing engine. Publisher selects the chapters that he/she wants from different books through web interface. Thus, these are inputs for a particular user specific purchase, rental, etc. order. All the order inputs associated with the custom document from web interface is stored in an XML file. A ‘Collation’ script reads information from the order XML file. If XML data is available for the selected chapters, it proceeds further to the step where the order is created, otherwise it displays up an error message stating that this particular chapter is not available in XML format and needs conversion. Once the XML data is available, then a folder is created by the order name. A processor and storage media are used to carry out the file creation and processing steps of FIG. 2.

Next, the processor-based system combines all the selected XML content from different books as a single XML file, adds all the necessary metadata information to the combined XML file, captures images for all the selected chapters from different books and places them in a subfolder called ‘images’. The next step is that it validates the combined XML content to ensure that the structure of the XML data is correct, fetches all the input parameter information such as type of template, ISBN, title name, author name, copyright information, etc. from a database (captured through web interface) and places all the information in an XML file. In one embodiment, the file can be called ‘parameter.xml’.

In general, all of the file names used herein are only examples and as such are non-limiting. The invention is not limited to XML based approaches and a specified file format conversion procedure can be automatically implemented in some embodiments to expedite work creation.

In another embodiment, as a next step, the software-based and processor-based system fetches permission information for images from a database (captured through web interface) and places all the information in an XML file called ‘permission.xml’, reads through the ‘permission.xml’ file and checks for the print permission value. If the value is ‘zero’, then it deletes the content of the whole image and also deletes or modifies its corresponding cross-references from the combined XML file. If the value is ‘one’, it retains the image content as is.

In yet another embodiment, the publishing engine receives two files (combined XML file and parameter.xml) as input. Combined XML is a structured list of the collated chapters in the order in which it was collated and also contains the custom content which the user has uploaded with reference to the chapter in which it was uploaded. Paramter.xml contains the customization information such as the new title, ISBN, template design specifications, etc. The engine transmits the combined XML file into the template chosen in ‘parameter.xml’. The layout of the book changes as per the template selected. It also makes use of one or more book or work parameters (e.g., font size, ISBN, cover image, etc.) and processes the data. Images are fetched automatically based on the cross-references in the combined XML file and placed near the nearest citation. If no copyright clearances are available for the images, then the images are automatically removed along with the cross references. No manual intervention is required in the process.

In another embodiment, a PDF can be generated by the publishing engine through the Arbortext Advanced Print Publisher (APP) (composition software) scripts or similar software. Arbortext Advanced Print Publisher is a software application which includes a typesetting tool. The entire automated process is developed through APP scripts. TOC, index and glossary are auto-generated based on the input from ‘parameter.xml’. Any layout or formatting adjustments are be input through XML file. Once all the changes are made, a PDF will be generated with a click on the button. Two PDFs (with watermark and without watermark) will be created. A review is performed on created PDF for visual appearance and then sent to the publishers. An automated review will be run on the PDFs to avoid any errors while printing the customized publication. The watermarked copy is of low resolution and is for review by the Publisher prior to making available the work for the public. The publisher approves of the work and the work is now available for the general public. In case the publisher does not send his approval, the customized work is not available for being uploaded onto the database and therefore not available to the public.

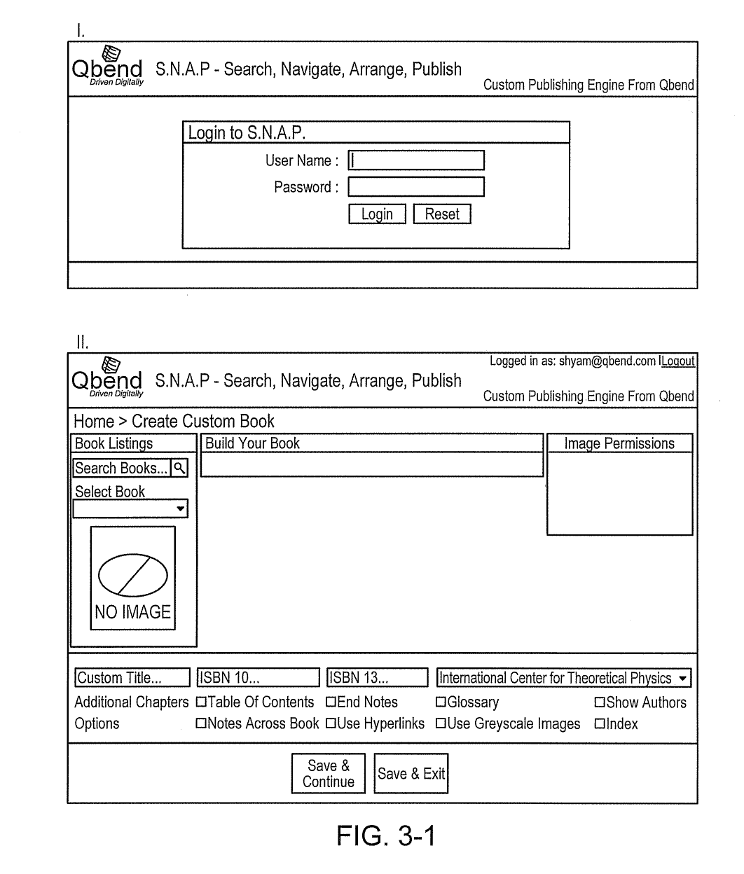

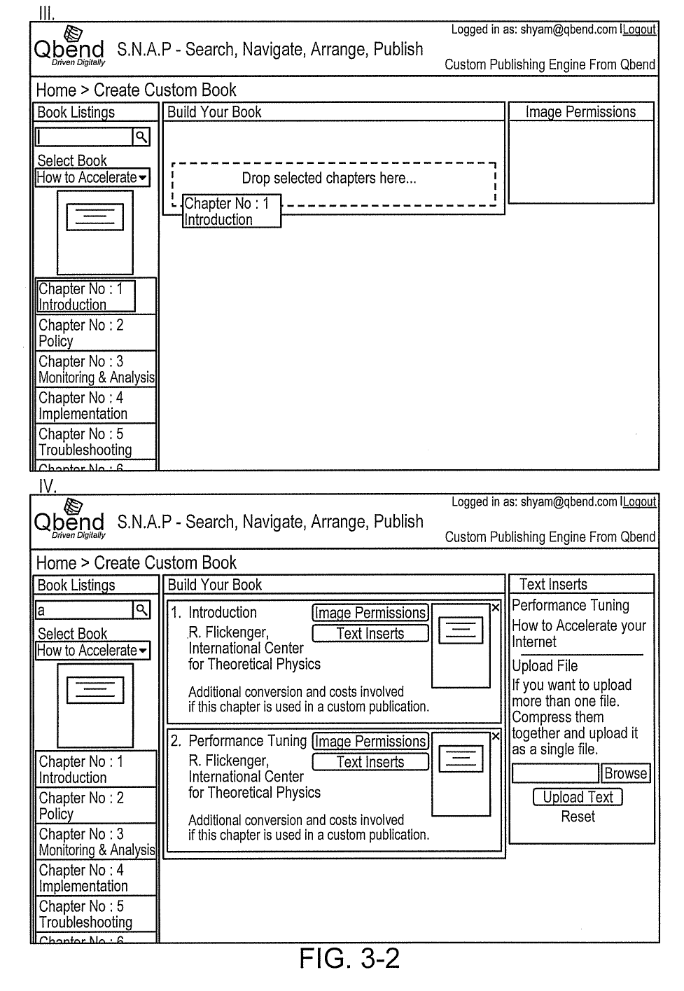

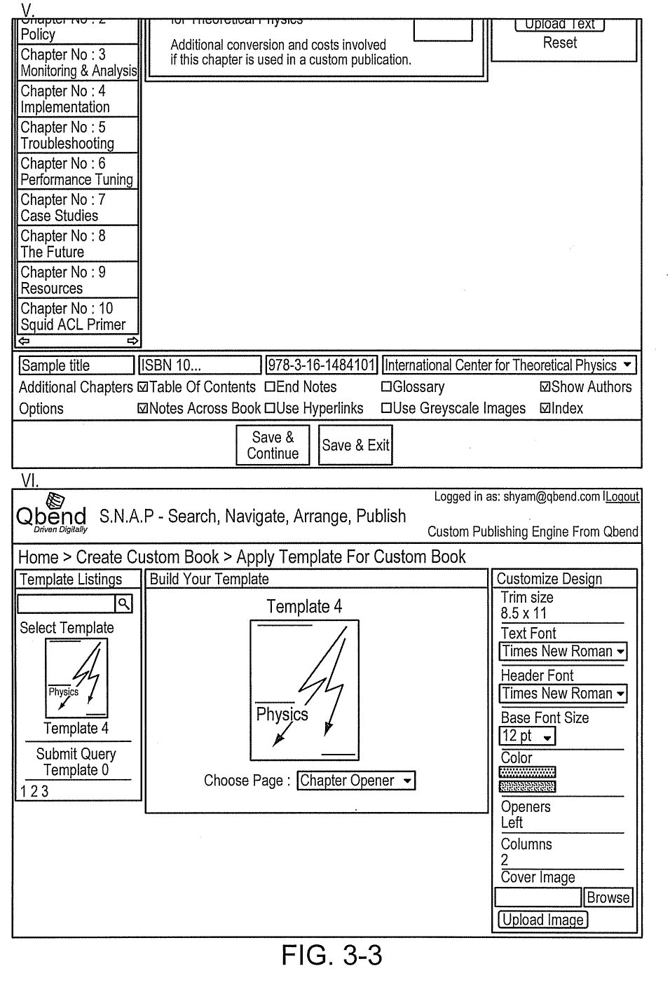

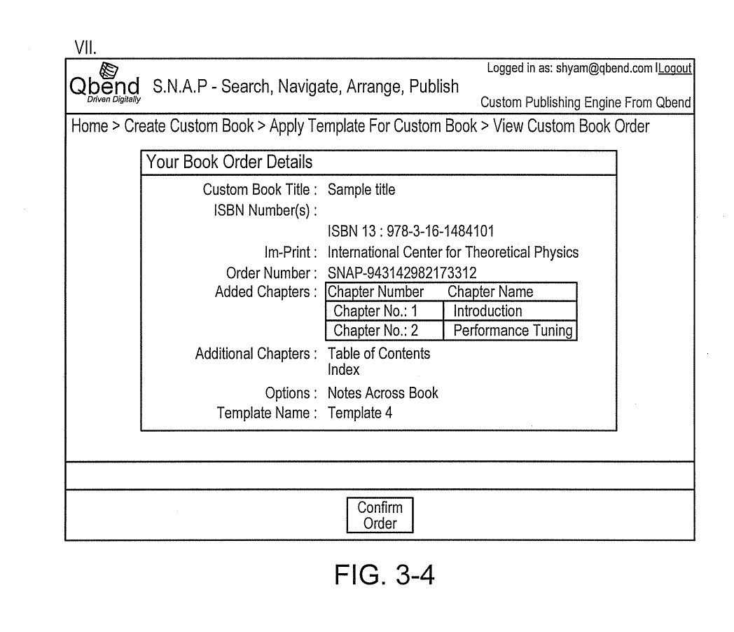

FIG. 3 is a series of screen shots for an exemplary publishing engine according to an embodiment of the invention. In one embodiment, the screen shots shown can be used to implement a custom publishing engine. Additional details with respect to the screenshots are as follows:
i. This screenshot shows the user authentication section that would provide access to the main custom publishing section.
ii. This screenshot shows the main custom publishing area, where the user can create a customized title from various content.
iii. This screenshot shows the process of adding a content element to the custom publishing work flow. The screen shows a chapter being added.
iv. This screenshot shows how the user can upload text inserts and also apply image permissions to selected content.
v. This screenshot shows the section where the user can input the details for the custom title and also select required options.
vi. This screenshot shows the template selection section for the custom publishing engine. The user will also be able to customize the fonts for the template.
vii. This screenshot shows the confirmation screen before confirming the custom publishing work order.

From these it is clear that the invention relates to a processor and software based system that incorporates user interfaces to perform the SNAP steps and generated custom works in and expedited and efficient manner from database stored text sections and/or images.

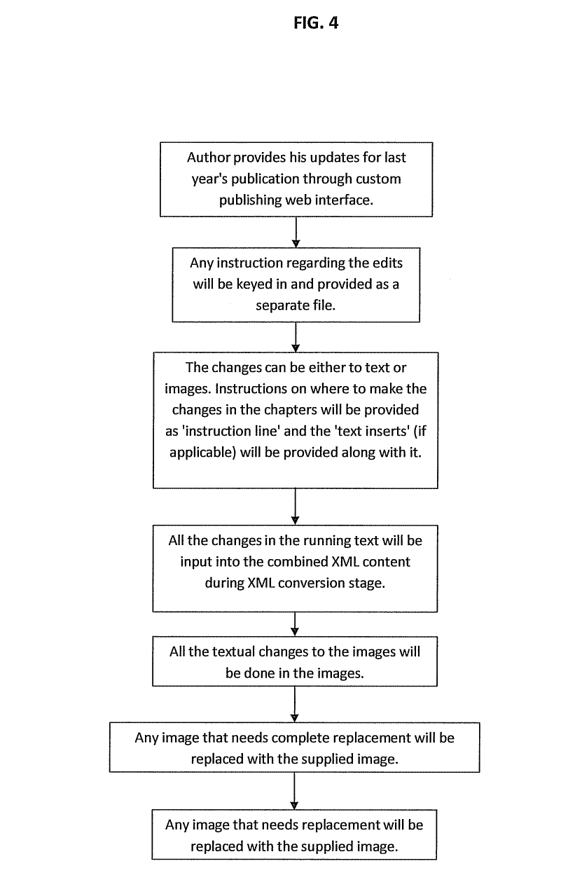

FIG. 4 is a flow chart depicting the operation of the edited customized publication, wherein the author can update the content of last year's publication during custom publishing. Any instruction regarding the edits will be keyed in and provided as a separate file. The publisher can upload the instruction file and along with the inserts, if any, with the option ‘Text Inserts’ in the custom publishing web interface. The changes can be either to text or images. Instructions on where to make the changes in the chapters will be provided as ‘instruction line’ and the ‘text inserts’ (if applicable) will be provided along with it. These instructions can be command based or use natural language to affect the changes. Here are some examples:

Instruction line:
Page 6, add new paragraph at end of last bullet list:

From the perspective of free content, traditional usages of copyright is limiting in several ways. For example, it limits the use of the work of the author to those who can, or are willing to, afford the payment of royalties to the author for usage of the author's content.

Instruction line:
Page 22, change all the occurrences of word ‘voltage’ to ‘vol.’ in the labels of FIG. 12.6.
(There is No ‘Text Insert’ for this Instruction Because the Instruction Line Itself has it.)
Instruction line:
Page 103, delete first full paragraph in its entirety and substitute the following:

Projects to provide free literature and multimedia content have become increasingly prominent owing to the ease of dissemination of materials that is associated with the development of computer technology. Such dissemination may have been too costly prior to these technological developments.

Instruction line:
Replace FIG. 3.2 with ‘prod-chart.eps’ (attached):
(There is no ‘text insert’ for this instruction because the instruction line itself has it.)

All the instructions provided in the instructions will be carried out during XML conversion process or as another part of the document or work creation. The computer system includes a parser in one embodiment to process these natural language or editing commands and automatically modify the documents based on the instructions.

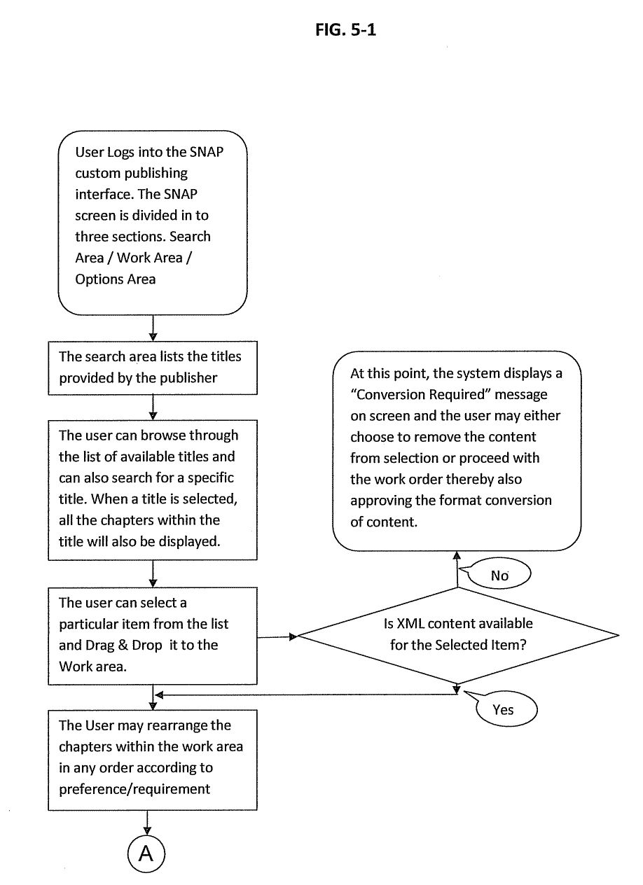

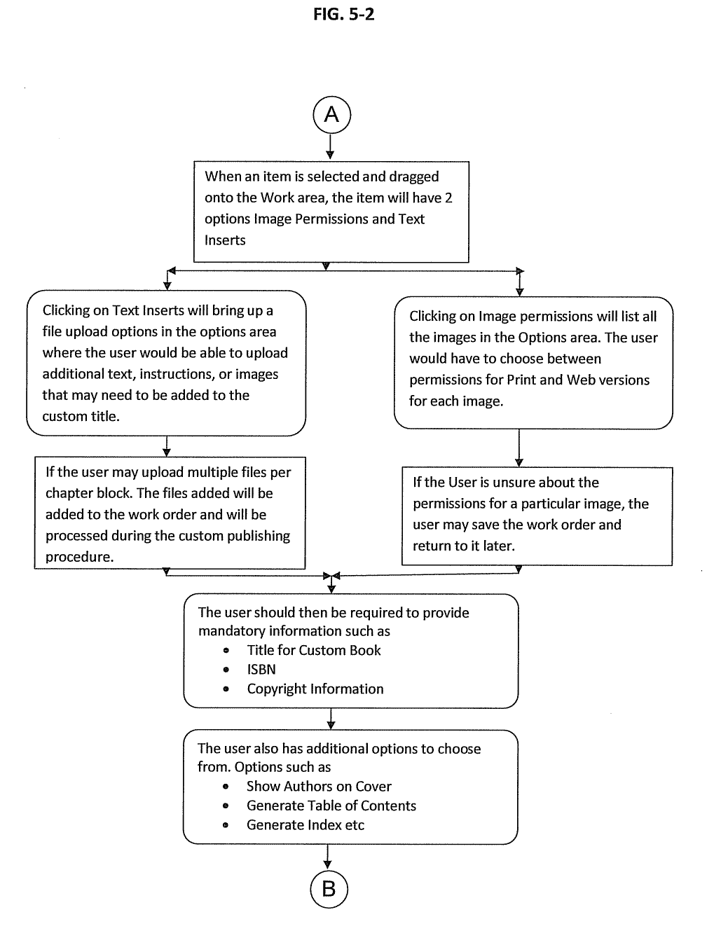

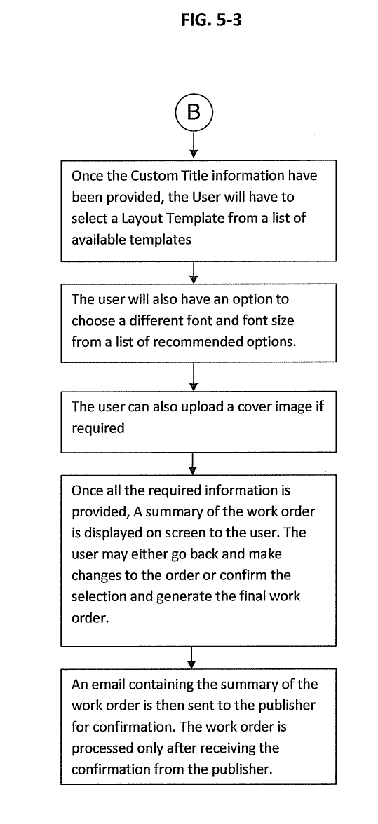

FIG. 5 is a block diagram illustrating the data structure of a relational storage database according to one embodiment of the invention. In one embodiment, a SQL server delivers data and manages various processes. It allows storage of data from structured, semi-structured and unstructured documents such as images and rich media, directly within the database.

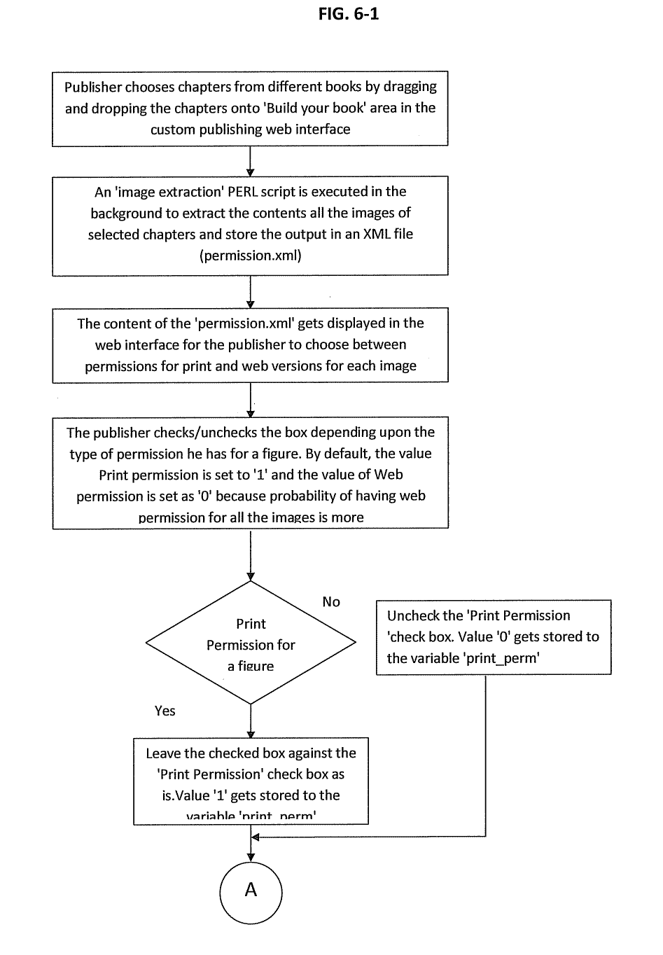

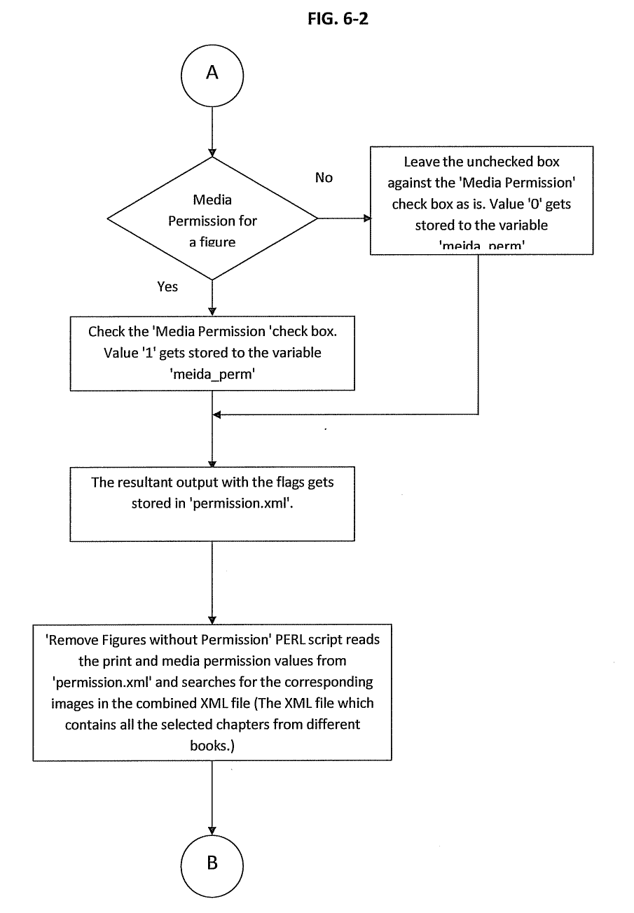

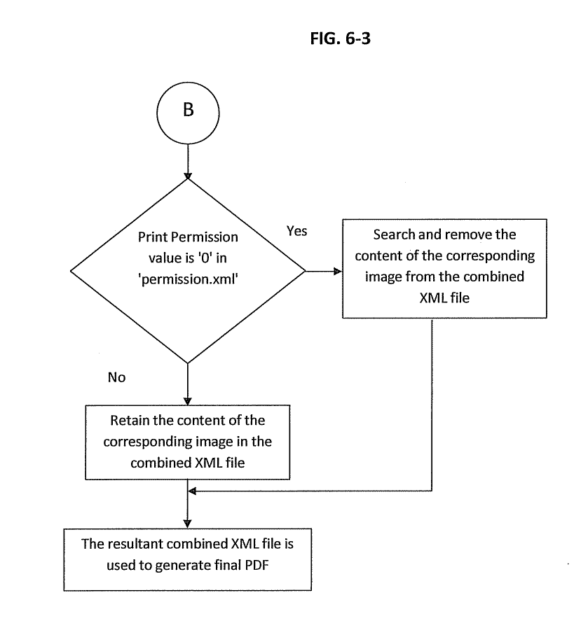

FIG. 6 illustrates a method for authoring a publication using a guided and structured document generation system according to one embodiment of the invention. FIG. 6 is a flow chart that relates, in part, to removal and processing of images. The publisher can review images in the chapters that are chosen for custom publishing and deselect any images that he does not want to appear in the publication. This is typically done when the publisher has no rights for publishing the image in any other publication. The publisher chooses the image permissions while choosing the chapters through custom publishing web interface. An ‘image extraction’ PERL script or other type of image extraction script is executed in the background to extract the contents all the images of selected chapters and store the output in an XML file (permission.xml). The content of the ‘permission.xml’ is displayed in the web interface for the publisher to choose between permissions for print and web versions for each image. In one embodiment, flags with toggle values are set in all the images to indicate the status of permissions.

Value ‘1’ is stored in the print/web permission variable, if the publisher checks the check box next to the Print permission or Web permission option in the web interface. Value ‘0’ is stored in the print/web permission variable, if the publisher unchecks the check box next to the Print permission or Web permission option in the web interface. The value Print permission can be set to ‘1’ and the value of Web permission is set as ‘0’ because probability of having web permission for all the images is more. The publisher checks/unchecks the box depending upon the type of permission he has for a figure. The boxes are part of a user interface presented to the publisher as part of the publisher interface with the overall system.

In one embodiment, these are defined as follows:

Print_perm=“1” or “0”-‘1’ indicates the publisher has permission to print the image in this publication and ‘0’ indicates otherwise.

Media_perm=“1” or “0”-‘1’ indicates the publisher has permission to display the image in any media and ‘0’ indicates otherwise.

For example, a custom publishing book may have 25 figures in it, but the publisher does not have print permission for the third figure and media permission for the fifth figure. The publisher typically identifies it by reading through the copyright information of the figure displayed in the custom publishing web interface. He scrolls through the images list, unchecks the print permission check box for FIG. 3 and unchecks the web permission check for FIG. 5. The resultant output with the flags gets stored in ‘permission.xml’. An example of the ‘permission.xml’ file (print and media permission values are highlighted in bold) is shown below:

<asset label=“Figure 1”><caption>Type specimen of the Velociraptor
skull</caption><copyright>American Museum of Natural
History</copyright><print_perm value=“1”/><media_perm
value=“0”/></asset>
<asset label=“Figure 2”><caption>Fossil <i>Protoceratops</i>
baby</caption><copyright>American Museum of Natural
History</copyright><print_perm value=“0”/><media_perm
value=“1”/></asset>

‘Remove Figures without Permission’ PERL script reads the print and media permission values from ‘permission.xml’ and searches for the corresponding images in the combined XML file that contains all the selected chapters from different books. If the print or media flag is set to ‘0’, then it removes the content of the corresponding image from the combined XML file. The removed image's corresponding text cross-references will be removed or modified as necessary by parsing the data.

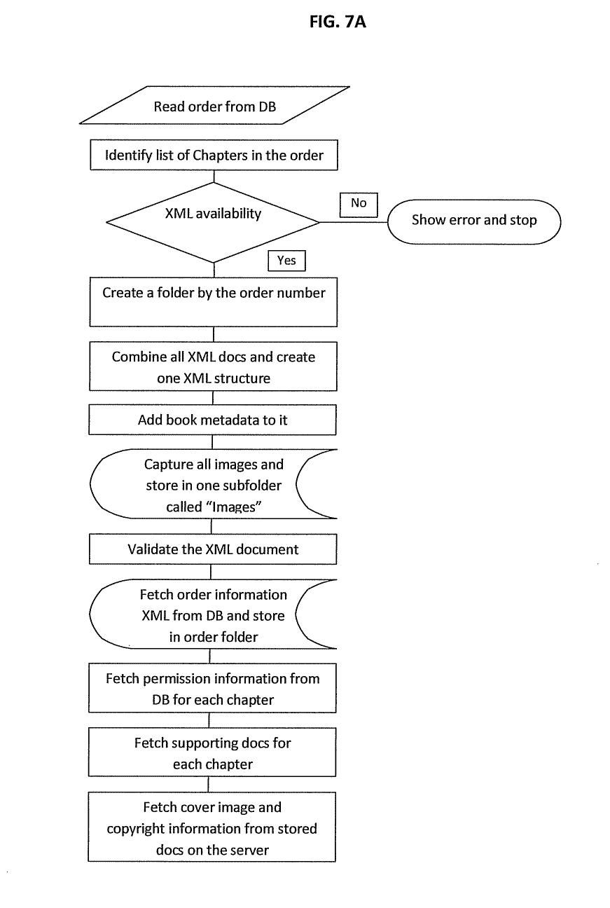

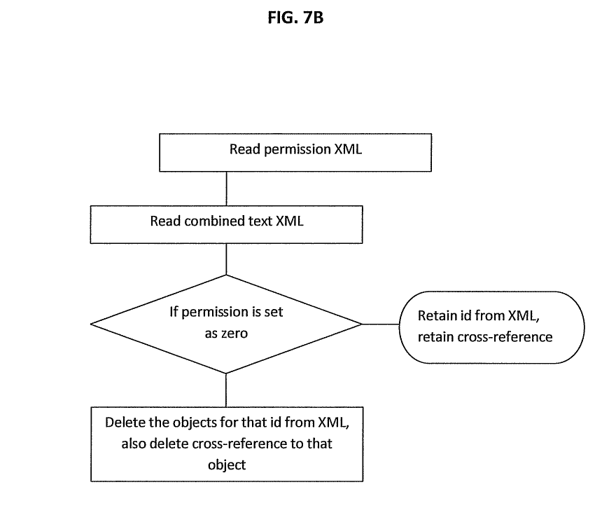

FIG. 7 illustrates a method for operating a publishing engine according to one embodiment of the invention. In one embodiment, all the content that is given to the service provider is in two formats namely PDF format and any other suitable format, for example, XML. Any book that needs custom publishing workflow typically uses XML data. The service provider creates the XML content for chapters that do not have XML available for them. Any edits that the author wants also will be input into the XML content at this stage. The service provider also stores images needed for the custom publications at the time of XML creation. The input for XML conversion can be of three types:
1. Previous edition application files (Quark, InDesign, Word, etc.)—Images will be provided along with the application file.
2. Previous edition final PDF.
3. Previous edition final XML files—Images will be supplied along with the XML files.
   1. Previous edition application files:
a. previous edition content can be saved as an HTML file
b. the resultant HTML content can be converted to XML using PERL script
c. a quality check will be performed on the converted XML files using Arbortext Editor™ and missing tags, if any, will be inserted
d. the output XML file will be parsed against the DTD to make sure the final output is well structured
e. images will be supplied along with the application files
   2. Previous edition final PDF:
a. previous edition content will saved as an HTML file
b. the resultant HTML content will converted to XML using PERL script
c. a quality check will be done on the converted XML files using Arbortext Editor™ and missing tags, if any, will be inserted
d. the output XML file will be parsed against the DTD to make sure the final output is well structured
e. images will be extracted from the final PDF using Adobe Acrobat
   3. Previous edition final XML files:
a. previous edition XML files will be converted to docbook XML using PERL script
b. a quality check will be done on the converted XML files using Arbortext Editor™ and missing tags, if any, will be inserted
c. the output XML file will be parsed against the DTD to make sure the final output is well structured
d. images will be supplied along with the previous edition XML files

DocBook specification is followed for XML conversion. As a semantic language, DocBook documents do not describe what their contents look like, but rather the meaning of those contents. For example, rather than explaining how the abstract for an article might be visually formatted, DocBook simply says that a particular section is an abstract. It is up to an external processing tool or application to decide where on a page the abstract should go and what it should look like.

The documents that need XML conversion are received at the facility in the form of either hardcopy manuscripts or editable word files. If the manuscript is in an uneditable format (i.e., hardcopy), these are double keyboarded. When a hardcopy manuscript is converted in to a digital copy, it is keyed in by two different people (double keyboarded) and in case of any discrepancy, the softcopy is then compared to the hardcopy to ensure that there is no error in the conversion and the output is derived as an editable text format or predominantly as word files. The files are then coded with XML tags. The external reference tags are added as needed. Once the files are done coding, they are parsed against the DocBook DTD to ensure compliance with the standard XML structure. Once compliance is achieved, the data is moved to the storage for any further re-purposing.

The content is edited using an automatic editor. A preferred embodiment of this is the user of Epic Editor™. As will be appreciated, similar software can be used in accordance with the invention. Arbortext Editor™ is a sophisticated toolset designed to help the author create and maintain documents in SGML and XML. With Arbortext Editor™, the author can create and edit SGML and XML documents in Windows and UNIX. The author can also edit SGML and XML documents created on other systems. Arbortext Editor™ documents can be transferred to any SGML or XML-compliant system. With Arbortext Editor™, the author can create and edit documents, edit tables in table or tagged mode, create and edit equations, import and export documents to and from other formats, personalize content through profiling, and perform several other tasks.

FIG. 7A is a part of the back end process of the custom publishing engine. It describes the process by which the customized content is to be collated in the new publication by pulling out the modifications/collation order and other information that is required to create the new publication from the existing parameter and the combined xml files.

FIG. 7B is also a part of the backend process of the custom publishing engine, where an object is to be removed for lack of permission, then the said object along with the relevant cross references are automatically removed.

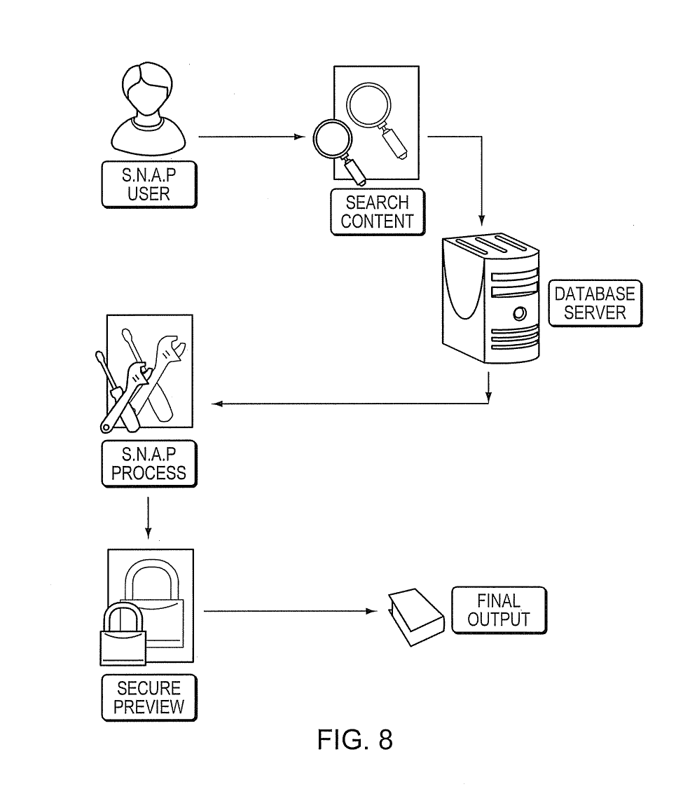

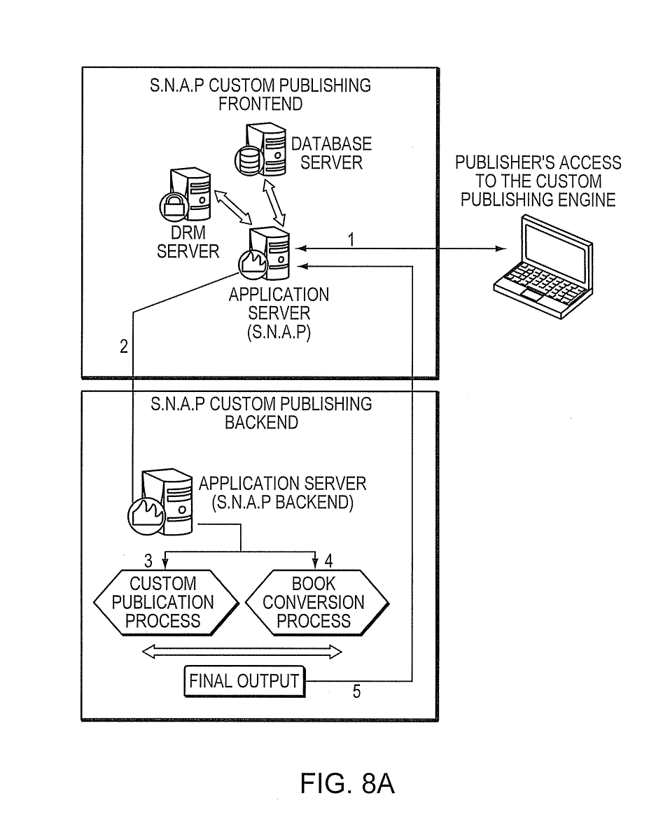

In part, this invention relates to an automatic authoring and publishing system. For example, FIG. 8 shows a system embodiment by which a user can search for content, assemble, preview and receive the final publication according to an embodiment of the invention.

Referring to FIG. 8A, a network cloud diagram is shown. A publisher accesses 1 the SNAP custom publishing engine. A customer order 2 is received by the backend application and is stored on the SNAP server. If the order is for a custom publication 3, the appropriate scripts are executed and the final product is created using Arbortext Advanced Print Publisher or similar software. If the order is for a conversion of content 4, then the appropriate scripts are executed and the final product is created using custom conversion tools. The final product 5 is then sent back to the publisher for review.

This system includes a document manager input interface, a storage database and a publishing engine. In various implementations, these components may be separate or integrated software modules that operate to guide the user/author in customizing a publication, defining data structures and allowable content, storing content as distinct data elements, providing information as to whether content is in a usable format, providing information as to whether content has copyright clearances, providing a preview of the publication prior to commercialization etc.

Further, the document manager input interface may include a document definition manager, a document builder, a paragraph editor, an automatic text generator etc. The document manager enables the author to build a document definition and allows managing data structures, creating templates, and managing task oriented function codes. The data structures are defined by the inventor/publisher. Page block, defining font types and/or other page formatting information for a document definition are also available through the document manager. The document manger may load a set of default structures that the author may customize. The builder module allows the creation of new work from one or more document definitions to create a revised instance based on a previous version. The document definition may define the type of permissible content for a particular field, section, paragraph or page.

Document Translations: By using structured document definitions, a translation into various other languages is facilitated. The tagging of standard terms or words such as ISBN, author's name, and publisher's name facilitates automatic translations. Such translations allows for translations within technical illustrations.

Structured Document Generation: This feature allows for a method of authoring a work using a guided and structured document. In one embodiment, document generation is defined based on a plurality of predefined data elements. One or more predefined data elements are edited using content specific selection menus. The data elements and/or document template are stored in a relational database to store a customized document.

Publishing Engine: In one embodiment, a publishing engine is also provided. The engine includes a structured document (e.g., XML) generator and any specified final document output format. The publishing engine operates in real-time as data is edited, added, deleted, etc. In one embodiment, the publishing engine uses a structured document (e.g., XML) as an intermediate step prior to publishing. In other embodiments the document output can be in any desired output format, for example, such as HTML, PDF, XML, SGML, RTF, plain text, etc.

In one embodiment, a document template for a particular document is selected. In other embodiments, the list of available document templates can be related to the final documents to be output from the system. Document template features may be selected or excluded from the document being authored by the author. These features may be selected or excluded on various levels of the document including by the chapter, section, and/or subject. Various data elements may also be cross-referenced and/or hyperlinked internally and between related documents. This permits storing content as structured data elements rather than as a single document. A set of tasks are then defined to be completed by an author in order to finalize or complete a document or manual. This may include customizing a document template for a particular type of product or operation. Thus, document templates and corresponding data structures are formed according to this method. The document is stored in the storage database with cross references and hyperlinks to common data elements. A compiled document is assembled with the data elements translated into a structured document format.

Another embodiment is a method for processing an internet-based client document change request application. A technical publication change request form is submitted by a client. The client is browser based in one embodiment. The submitted technical publication change request form is automatically sent to a reviewer for validation. For example, certain fields may be required to be completed before the request can be assigned, or the submission is returned to the requester with a request for the missing information. The revised document is reviewed for errors and is then sent for independent review to the publisher to ensure accuracy prior to being used for commercial purposes.

Another embodiment provides an apparatus comprising a machine readable medium containing instructions that, when executed, cause the machine to perform operations of loading a predefined document template. Parts of the predefined document template can then be selected or excluded from the document. Individual document elements are retrieved from a storage database. Individual document elements are inserted into the predefined document definition. Text is automatically generated and inserted into the predefined document definition. The predefined document definition and the individual document elements are stored together as a new document in the storage database. An output format for the new document is selected. The new document is then encoded as an extensible markup language file. The new document is then published in the output format selected.

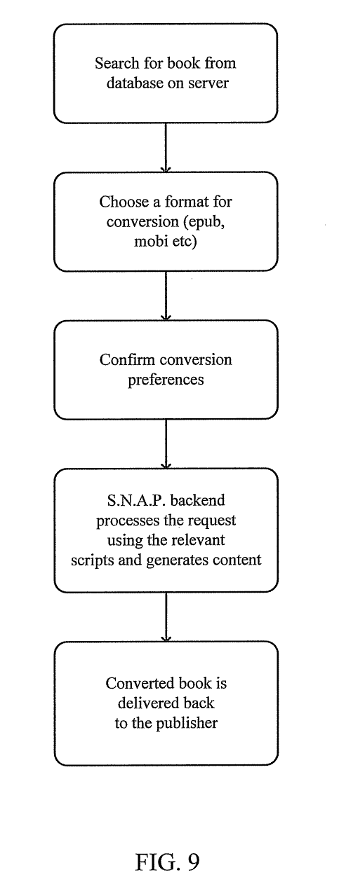

With respect to FIG. 9, yet another feature of this invention is the option given by the publisher to the user/author for conversion of his work from one format to another by means of, for example, the Click Book Convert. Click book convert is an option which the publisher can exercise, when opting for conversion of his work. Once the option to convert is exercised, then the SNAP system generates a parameter xml and a combined xml that contains the relevant information to enable the conversion process. These xml files are used as inputs and the conversion is performed backend using proprietary tools belonging to the service provider (i.e. custom created scripts). This feature allows the publisher to select a particular book from the repository and gives them an option to change that particular title from one format to another. This is to overcome the drawback that some of the content is available only in a particular format not suited for publication. The author/user selects a title from the list of available books and selects a destination format. The source content could be in PDF or XML format. Based on the user's preference for conversion a compatible script/conversion application will be invoked to convert the source file into the preferred format.

The document authoring and generation system has several advantages over the prior art in terms of data production, distribution, modification, and usage. Data distribution is improved by having more complete data sources, improved document and data delivery time, and decreased shipping costs (e.g., electronic data shipping versus paper documents/manuals). Data modification is improved by decreasing the time needed to incorporate modifications, decreasing the costs of re-authoring or editing a document, and making possible automatic translation of documents (e.g., into different languages or formats). Data usage is improved by retrieval software/browsers resulting in improved access time to digital data, searching of pertinent data utilizing the intelligence of the data structure, and customization of data based on document definitions.

The data revision process is also improved in terms of revision control, revision time, and automated revision markings. What has been described is a new and improved system and method for exercising the option of customizing the publications by either the user or the publisher through authorized persons. The concept of owning portions of a book either completely by way of purchase or renting it for a period is innovative and novel and offers many advantages relative to existing offerings.

Another search or query related feature is the ability to track the predefined data element across multiple documents. This predefined data comprises the words that occur in the index of the publications, which are listed chapterwise for each publication. The plurality of predefined data elements may be selected from the group consisting of text, quantity, descriptions, procedures, and graphical metadata which occur in the index of the publications. The step of editing one or more of the predefined data elements may include performing tasks pre-associated with the predefined data elements. The predefined data elements or selected data elements may be cross-referenced to one or more other documents. The content-specific selection menus may be dynamically generated based on a defined content type of the document definition.

In accordance with one embodiment of the invention, the group of publishers who convey or transfer their content to a service provider can do so in two or more formats. One such format is the PDF and the other such format is the XML or any other formats currently used in the Industry. The first step however, in this invention is loading the content on to the server of the service provider.

When a user enters the website of the service provider, he has an option of browsing through journals, publications, etc. These can be bought, rented or subscribed to as desired by the user. The payment for these is through the normal methods used in the industry. The user can be either a registered member or a visitor. Once logged in, the user chooses a particular topic to browse, thereby choosing a particular area of interest. The various groups under which these publications are listed as categories. Depending upon his interest, a user enters a particular field, for example, science, mathematics, etc. Once he enters the category, then he enters the search terms.

The search used is an advanced search engine which provides the user with a list of publications, the relevant chapters in which the search terms are occurring, information about the publisher, the author of the work, the ISBN, the cover image of the publication, price of the book, etc. The user then goes through the search list and narrows the search to exactly what he wants and then downloads these items by using the purchase or renting options.

The search result is generated from print data which comprises a plurality of digitized pages that are searchable following a character recognition processing on the digitized pages. The search further comprises the step of generating a search index from the relevant database, wherein both the data and the metadata are searched correlating the query to at least one publication specification result contained in the database.

Once the user decides on the items to be purchased, he drags and drops those choices into the purchase cart and then pays for the same. The items that have been purchased are now available in the download basket until the download process is complete. Once the download is complete, then items are moved to the download history that tracks purchases, time of purchase, how many copies were ordered, re-ordering, etc.

With regard to editing of the content, the authorized personnel logs on to the website through an authorization from the publisher. Once his authorization is allowed, access to the content of the publisher in the database is granted. Next, content is selected for publication from the database. Once the chapters are identified, they are dragged and dropped into the work basket. Once the selection process is over, the work order is processed.

As mentioned earlier, some of the chapters identified by the author may not be available in an XML format. The author is informed of this situation and the author can request conversion into the XML format. In one embodiment only after all the chapters are available in the XML or another specified format, the author is able to move to the next stage, namely, the permission zone.

If there are any images, then the author has to check if there is any permission (copyright, license, etc.) to re-use the same. Only after such clearances are confirmed by the relevant owner can the author use these images. If no such permission is available, then the images along with related text are removed from those chapters and the remaining content is available for the author to work on. This ensures legal compliance of purchased combination. Thus, an electronic system with permission controls for making and owning derivative works of other authors is implemented using a user interface based approach.

The author can now specify if he wants to upload any files that he may wish to add to the content and can do so by specifying the page and the paragraph before or after which this content is to be added. Once all the additions and deletions are complete, the author can tick off a check list in which there are certain items like the ISBN, copyright sanctions, etc. In some embodiments, the permission clearances are all mandatory.

The next stage in creating such a custom publication is that the customized work is now created in duplicate and the watermarked copy is sent to the publisher for final approval. On receiving the approval the customized publication is available for purchase, rent, etc. In some embodiments, the turnaround time for this entire activity is around 48 to 72 hours or less, which is fast when compared to the three to four week time frame under traditional methods.

The customized document may be previewed prior to publishing. The customized document may be published by performing the steps of: (1) converting the customized document into an extensible markup language document; (2) forwarding the extensible markup language document to an extensible stylesheet transform; and/or (3) outputting the extensible markup language document from the extensible stylesheet transform as a published document. An internet-based change request may be received to make change to the published document. This method may also be implemented on hardware, software, or a combination thereof.

In part, the invention relates to a processor-based system for generating publishable information of interest to a user. The computer system includes a memory device and a processor in communication with the memory device. In turn, the memory device includes instructions that, when executed by the processor, cause the processor to perform various combinations of the steps shown in the attached figures.

The present invention may be embodied in many different forms, including, but in no way limited to, computer program logic for use with a processor (e.g., a microprocessor, microcontroller, or general purpose computer), programmable logic for use with a programmable logic device, or any other means including any combination thereof.

A browser-based approach can be used to implement various embodiments of the invention. In addition to a browser-based application, an overall system including certain hardware components, such as servers that allow for some of the various data assembly and publishing and pre-publishing steps described herein can also be used. Servers suitable for performing the processing, routing, parsing, transmission, transformation of data into a publication of interest to a user can use a Windows-based operating system, a Mac-based operating system, a Linux-based operating system, or any other suitable open source or proprietary operating system.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system.

Memory may also include any means for storing software or other instructions including, for example and without limitation, a hard disk, an optical disk, floppy disk, DVD (digital versatile disc), CD (compact disc), memory stick, flash memory, ROM (read only memory), RAM (random access memory), DRAM (dynamic random access memory), PROM (programmable ROM), EEPROM (extended erasable PROM), and/or other like computer-readable media.

In general, computer-readable memory media applied in association with embodiments of the invention described herein may include any memory medium capable of storing instructions executed by a programmable apparatus. Where applicable, method steps described herein may be embodied or executed as instructions stored on a computer-readable memory medium or memory media. These instructions may be software embodied in various programming languages such as C++, C,)(NIL, HTML, Ruby on Rails, Java, and/or a variety of other kinds of software programming languages that may be applied to create instructions in accordance with embodiments of the invention.

It is also another aspect of this invention that this invention directly results in financial benefits to both the publisher and the inventor as detailed herein.

This invention provides a lower cost of production for publishers with faster turnaround, as it does away with hard copy printed publications and assembles the publication digitally, thus driving the whole publication production digitally, saving not only time but also availability of the publication within a 48-72 hour period from the time the request is made to the publisher.

This invention also drives more sales for publishers to sell their core textbooks to educational institutions that use this invention to produce their custom content.

This invention further adds more value to the publishers by producing better quality content at a lower price at a fraction of the time that it takes for a hard copy to be published.

This invention significantly saves money for the publishers that they need to invest in research and development by making available to them XML-based tools for creating custom products.

This invention provides conversion options to other formats through a unified interface which would cost the publishers more if done separately.

This invention directly results in more revenues for the publisher as every single query has the potential to be converted into a sale as the customized content that is selected or desired by a customer can result in a publication.

This invention further facilitates the customization of the same topic by various authors, publishers, etc., all available under one umbrella.

This invention results in increased revenue for the applicant by producing custom publications.

This invention also results in increased revenue for the applicant by multi-channel publishing.

Another aspect of this invention is that the umbrella that is provided to different publishers results improved market share for custom publishing.

Referring to FIG. 9, yet another feature of this invention is the option given by the publisher to the user/author for conversion of his work from one format to another by means of the Click Book Convert feature.

The examples presented herein are intended to illustrate potential and specific implementations of the invention. It can be appreciated that the examples are intended primarily for purposes of illustration of the invention for those skilled in the art. There may be variations to these diagrams or the operations described herein without departing from the spirit of the invention. For instance, in certain cases, method steps or operations may be performed or executed in differing order, or operations may be added, deleted or modified.

Although the present invention has been described with a degree of particularity, it is understood that the present disclosure has been made by way of example. Since various changes could be made in the above description without departing from the scope of the invention, it is intended that all matter contained in the above description or shown in this provisional specification shall be illustrative and not used in a limiting sense.

What is claimed is:

1. An automated publishing system comprising:
a server comprising a processor, a storage device, and a database indexed to store contribution data, wherein the contribution data comprises portions of a plurality of works of authorship provided by a publisher;
a user authentication system configured to authenticate a contribution user and grant permissions to at least one member, wherein the contribution user can collate content from the database or populate the database with contribution data and request the service provider to customize such content into custom publications; and
a virtual work area having a graphic user interface accessible by the at least one member using a browser, wherein the interface comprises content searching and content collating features such that the at least one member can generate a custom work by selecting a plurality of different portions of works of authorship, wherein the selected plurality of different portions are combined using the processor in response to a member action using the interface, to generate the custom publication;
wherein the custom publication is made available after the publisher approves the custom publication.

2. The system of claim 1 further comprising an image permission subsystem that evaluates images selected for inclusion in the custom work and authorizes the inclusion of the image if certain permission values are detected.

3. The system of claim 1 wherein the portions of a plurality of works of authorship are structured data elements.

4. The system of claim 3 wherein the portions are selected books classified chapterwise.

5. The system of claim 1 wherein the contribution user or the at least one member is selected from the group consisting of publisher, content aggregator, university, online merchant, student, researcher, renter, and combinations thereof.

6. The system of claim 1, wherein the database includes a plurality of contribution fields to store contribution data, wherein the contribution data can be stored as individual units or as an aggregation of such individual units.

7. The system of claim 1, wherein software executing on the processor receives information collated by the contribution user and generates an XML based configuration file in response thereto.

8. The system of claim 1, wherein each portion is stored as a logical content unit.

9. The system of claim 8, wherein image use permission information for each logical content unit is stored as a separate XML file in an associated permission entry in the database.

10. The system of claim 1, wherein the virtual work area provides conversion options to other formats through a unified interface.

11. A computer system for publishing a custom digital work, the computer system comprising:
an electronic memory device; and
an electronic processor in communication with the memory device, wherein the memory device comprises instructions that when executed by the processor cause the processor to:
process a plurality of selected sections from different works;
store the sections input through the interface in an order file;
determine availability of a common file format for the plurality of sections stored in a database by reading contents of the order file;
if common file format does not exist, convert files associated with the plurality of sections to the common file format; and
combine the plurality of selected sections using the common file format to generate the custom digital work.

12. The system of claim 11, wherein the instructions further cause the processor to:
add metadata to the custom digital work;
obtain permission information to add or remove images to the digital work; and
add digital work publication information to the digital work.

13. The system of claim 11, wherein the common file format is XML.

14. The system of claim 12, wherein the digital work publication information is selected from the group consisting of template, ISBN, title name, author name, copyright information, and format.

15. The system of claim 11, wherein the permission information is retrieved from a database and stored in a permission file.

16. The system of claim 1, wherein the instructions further cause the processor to:
read the permission file and check for a print/web permission value.

17. The system of claim 16, wherein the instructions further cause the processor to:
delete an image if the print/web permission value is a first value and retain the image if the print/web permission value is a second value.
